(19) United States
(12) Patent Application Publication
(10) Pub. No.: US 2003/0101268 A1
(43) Pub. Date: May 29, 2003

(54) High-level extensible markup language (XML) structure and communication process

(76) Inventors: David Scott Davidson, Albuquerque, NM (US); Douglas G. Trotter, Albuquerque, NM (US)

Correspondence Address: Roberts Abokhair & Mardula, LLC, Suite 1000, 11800 Sunrise Valley Drive, Reston, VA, 20191-5302, US

(21) Appl. No.: 10/151,568

(22) Filed: May 20, 2002

Related U.S. Application Data
(60) Provisional application No. 60/292,068, filed on May 18, 2001.

(51) Int. Cl. G06F 15/16

(52) U.S. Cl. 709/227

(57) ABSTRACT

The present invention provides communications between networked computing devices using a high-level Extensible Markup Language (XML) structure. A plurality of desired transactions to be communicated between the networked computing devices are defined and an XML schema is established for each transaction. Communication session state information is maintained on each computing device during a session. Text-based transaction messages are sent between the networked computing devices using Hypertext Transport Protocol (HTTP) and can include both data and instructions. In one preferred embodiment, the networked computing devices are an Internet web server and a wireless patient monitor and said text-based transaction messages are used to provide bi-directional transmission of data and instructions.

### RELATIONSHIP TO PRIOR APPLICATIONS

This application claims the benefit of U.S. Provisional Application No. 60/292,068, filed May 18, 2001 and hereby incorporated by reference.

### FIELD OF THE INVENTION

The present invention is drawn to a high-level Extensible Markup Language (XML) structure and communication process. More particularly, the invention discloses specific XML schemas and processes for providing communications between networked computing devices, such as wireless communication between a web server and a remote wireless device or between web servers.

### BRIEF SUMMARY OF THE INVENTION

It is an object of the invention to implement communications between computerized devices with compact message length to decrease bandwidth requirements.

It is a further object of the invention to provide communications between a computerized devices having reliability sufficient for critical applications.

It is another object of the invention to provide bidirectional transmission of both data and instructions between computerized devices.

It is another object of the invention to maintain knowledge of a current communications state during communications between computerized devices.

It is an object of the invention to implement flow of control, prioritization, and interrupts in communications between computerized devices.

It is yet another object of the invention to implement error handling in communications between computerized devices.

It is an object of the invention to implement communications between networked servers to handle large volumes of information, such as patient database records.

It is a further object of the invention to provide communications between networked servers having error handling for invalid data record transactions.

It is another object of the invention to provide communication between networked computer devices of more than one type of transaction set (data, instructions) at a time.

It is another object of the invention to improve readability and maintainability of information during communications between computerized devices through use of descriptive XML schemas.

It is an object of the invention to implement secure communications between computerized devices, such as for patient information.

It is yet another object of the invention to provide communications between disparate hardware, software, and databases.

It is an object of the invention to implement wireless communications between a web server and a remote device with compact message length to decrease wireless airtime.

It is a further object of the invention to provide wireless communications between a web server and a remote device having reliability sufficient for patient measurements/monitoring.

It is another object of the invention to provide bidirectional wireless transmission of both data and instructions between a web server and a remote device.

It is another object of the invention to maintain knowledge of a current communications state during wireless communications between a web server and a remote device.

It is an object of the invention to implement flow of control, prioritization, and interrupts in wireless communications between a web server and a remote device.

It is yet another object of the invention to implement error handling in wireless communications between a web server and a remote device.

### BRIEF DESCRIPTION OF THE DRAWING

FIG. 1 is a flow chart of a basic embodiment of the process of the present invention.

FIG. 2 is a schematic diagram of one preferred embodiment of the system of the present invention.

### DETAILED DESCRIPTION OF THE INVENTION

The XML schemas and communications process of the present invention enable bi-directional exchange of electronic messages between computers and/or computerized devices in a distributed environment. The same communications process works across LANs, WANs, the Internet, and wireless connections. Since messages are text based and use the HTTP protocol, multiple platforms can be used to run the communications process including MS Windows®, Unix, Macintosh®, and wireless operating systems. The present invention allows for content diversity, wherein data, requests for data, and any other type of processing instructions between electronic systems can be communicated using this process.

Processing rules can be included in the schemas, the transformations, and the general code to allow for specifications to be tailored on a client-by-client basis. The present invention provides flow control such that the control of the message flow, priorities, and interrupts can be managed on either end. Information about the state of the communications session (i.e., session state) can be maintained at both ends while still employing stateless communications through HTTP.

The communications error handling includes error handling for message transport and communications format and the data error handling includes error handling for data and data formats contained within the message. Because the system can use the HTP and HTTPS protocols, standard SSL is available for encryption and security. VPN and any other client-specific security system which works with HTTP will also work with this communications process.

The present invention also provides sufficient redundancy and reliability needed for critical applications, such as medical communications. By maintaining state information on both sides, a message can be resent as many times as necessary. The HTTP protocol itself guarantees further reliability.

Additionally, the present invention is efficient and scalable. XML message length can be minimized for optimal wireless communication speed and efficiency. A single message can hold everything from a single data point to the patient information for 100,000 patients. With multiple messages the total amount of data that can be conveyed is limited only by the total time and bandwidth restrictions of the hardware involved. Because methods are built-in for managing data and instructions, this communication process allows procedures to be automated that previously had to be done manually.

Other advantages of the present invention include:

improved flexibility since various types of transactions and data can be grouped into transaction sets where all of the diverse transaction sets can then be grouped into a single message;

improved readability since the messages written in ASCII text allow for faster and easier understanding, troubleshooting, and maintenance; and

ease of development since use of the XML specification means that all of the many XML of tools and utilities for development can be used and most developers will be familiar with the language, leading to faster and less expensive project development.

Two exemplary uses of the present invention are described below and include schemas and samples from a patent data monitoring project and web server communication (“Sleep Solutions”) project.

### Patient Data Monitoring

In the patient data monitoring embodiment, the present invention is implemented for wireless communications between a web server (PhDx) and a remote patent data monitor (PDM) in the form of a personal sensor device (PDM2000) by using an XML message schema, an XML transaction schema for scheduled sensor data, and an XML transaction schema for acknowledgement (ACK) data.

### XML Message Schema

The XML schema used to validate the high-level XML message structure is shown below:

<?xml version=“1.0”?>
<Schema

name=“PhDxPDM2000MSGSchema”
xmlns=“urn:schemas-microsoft-com:xml-data”
xmlns:dt=“urn:schemas-microsoft-com:datatypes”>
<ElementType name=’MSG' content=’eltOnly'>

<element type=’MID' minOccurs=’1' maxOccurs=’1'/>
<element type=’MDT' minOccurs=’1' maxOccurs=’1'/>
<element type=’MTY' minOccurs=’1' maxOccurs=’1'/>
<element type=’CNM' minOccurs=’1' maxOccurs=’1'/>
<element type=’CID' minOccurs=’1' maxOccurs=’1'/>
<element type=’EID' minOccurs=’1' maxOccurs=’1'/>
<element type=’RID' minOccurs=’1' maxOccurs=’1'/>
<element type=’TCT' minOccurs=’1' maxOccurs=’1'/>
<element type=’TRA' minOccurs=’1' maxOccurs=’*'/>

</ElementType>
<ElementType name=’MID' content=’textOnly' dt:type=’int'/>
<ElementType name=’MDT' content=’textOnly'
dt:type=’dateTime'/>
<ElementType name=’MTY' content=’textOnly' dt:type=’int'/>
<ElementType name=’CMM' content=’textOnly' dt:type=int'/>
<ElementType name=’CID' content=’textonly' dt:type=int'/>
<ElementType name=’EID' content=’textOnly' dt:type=int'/>
<ElementType name=’RID' content=’textOnly' dt:type=int'/>
<ElementType name=’TCT' content=’textOnly' dt:type=int'/>
<ElementType name=’TRA' content=’eltOnly'>

<element type=’TID' minOccurs=’1' maxOccurs=’1'/>
<element type=’TCD' minOccurs=’1' maxOccurs=’1'/>
<element type=’TVL' minOccurs=’1' maxOccurs=’1'/>

</ElementType>
<ElementType name=’TID' content=’textOnly' dt:type=’int'/>
<ElementType name=’TCD' content=’textOnly' dt:type=’int'/>
<ElementType name=’TVL' content=’eltOnly'/>

</ Schema>

### XML Transaction Schema—Scheduled Sensor Data

The XML schema used to validate the lower-level XML transaction structure for a scheduled sensor data post is shown below. A separate schema exists for each of the different transaction types.

<?xml version=“1.0”?>
<Schema

name=“PDM2000Schema_POSTSCHEDULEDSENSORDATA”
xmlns=“urn:schemas-microsoft-com:xml-data”
xmlns:dt=“urn:schemas-microsoft-com:datatypes”>
<ElementType name=’TVL' content=’eltOnly'>

<element type=’TVO' minOccurs=’1' maxOccurs=’1'/>
<element type=’TVT' minOccurs=’1' maxOccurs=’1'/>
<element type=’TVH' minOccurs=’1' maxOccurs=’1'/>
<element type=’DSS' minOccurs=’1' maxOccurs=’1'/>
<element type=’DES' minOccurs=’1' maxOccurs=’1'/>

</ ElementType>

<ElementType name=’TVO' content=’textOnly' dt:type=’int'/>
<ElementType name=’TVT' content=’textOnly' dt:type=’float'/>
<ElementType name=’TVH' content=’textOnly' dt:type=’int'/>
<ElementType name=’DSS' content=’textOnly' dt:type=’bin.hex'/>
<ElementType name=’DES' content=’eltOnly'>

<element type=’CCC' minOccurs=’1' maxOccurs=’1'/>
<element type=’CBC' minOccurs=’1' maxOccurs=’1'/>
<element type=’TSI' minOccurs=’1' maxOccurs=’1'/>
<element type=’OSI' minOccurs=’1' maxOccurs=’1'/>
<element type=’PAC' minOccurs=’1' maxOccurs=’1'/>
<element type=’CER' minOccurs=’1' maxOccurs=’1'/>
<element type=’PRF' minOccurs=’1' maxOccurs=’1'/>
<element type=’MOD' minOccurs=’1' maxOccurs=’1'/>
<element type=’PAU' minOccurs=’1' maxOccurs=’1'/>

</ElementType>

<ElementType name=’CCC' content=’textOnly' dt:type’int'/>
<ElementType name=’CBC' content=’textOnly' dt:type’int'/>
<ElementType name=’TSI' content=’textOnly' dt:type’int'/>
<ElementTyPe name=’OST' content=’textOnly' dt:type’int'/>
<ElementType name=’PAC' content=’textOnly' dt:type’int'/>
<ElementType name=’CER' content=’textOnly' dt:type’int'/>
<ElementType name=’PRF' content=’textOnly' dt:type’int'/>
<ElementTyPe name=’MOD' content=’textOnly' dt:type’int'/>
<ElementType name=’PAU' content=’textOnly' dt:type’int'/>

</Schema>

### Example—Scheduled Sensor Data Post

The scheduled sensor data transaction posts the personal sensor measurements (taken as scheduled by the PDM's internal sensor profile settings) from the PDM to the server. As shown in the table below, this transaction contains the sensor values, the device standard status, and the device extended status.

The full set of message tags is as follows:

<MSG>

<MID>MESSAGE_ID</MID>
<MDT>MESSAGE_DATE</MDT>
<MTY>DATAPOSTSET</MTY>
<CMM>COMM_MODE</CMM>
<CID>CLIENT_ID</CID>
<EID>EXTERNAL_ID</EID>
<RID>0</RID>
<TCT>1</TCT>
<TRA>

<TID>TRANSACTION_ID</TID>
<TCD>SCHEDULED_SENSOR_DATAPOST</TCD>
<TVL>

<TVO>100</TVO>
<TVT>98.6</TVT>
<TVH>75</TVH>
<DSS>PDM_STANDARD_STATUS_16_BYTE_RECORD</DSS>
<DES>

<CCC>0</CCC>
<CBC>0</CBC>
<TSI>0</TSI>
<OSI>0</OSI>
<PAC>0</PAC>
<CER>0</CER>
<PRF>0</PRF>
<MOD>0</MOD>
<PAU>0</PAU>

</DES>

</TVL>

</TRA>

</MSG>

### XML Transaction Schema—Acknowledgement (ACK)

The XML schema used to validate the lower-level XML transaction structure for a message acknowledgement (ACK) is shown below. A separate schema exists for each of the different transaction types.

<?xml version=“1.0”?>
<?xml version=“1.0”?>
<Schema

name=“PDM2000Schema_ACK
xmlns=“urn:schemas-microsoft-com:xml-data”
xmlns:dt=”urn:schemas-microsoft-com:datatypes”>
<ElementType name=’TVL' content=’eltOnly'>

<element type=’VAL' minOccurs=’1' maxOccurs=’1'/>

</ElementType>

<ElementType name=’VAL' content=’textOnly'
dt:type’string'/>

</Schema>

### Example—The Acknowledge (ACK) Message

The Acknowledge (ACK) message is defined as follows:

<MSG>

<MID>MESSAGE_ID</MID>
<MDT>MESSAGE_DATE</MDT>
<MTY>ACK</MTY>
<CMM>COMM_MODE</CMM>
<CID>CLIENT_ID</CID>
<EID>EXTERNAL_ID</EID>
<RID>REFERENCE_MESSAGE_ID</RID>
<TCT>1</TCT>
<TRA>

<TID>TRANSACTTON_ID</TID>
<TCD>ACKTRAN</TCD>
<TVL>

<VAL>VALUE</VAL>

</TVL>

<TRA>

</MSG>

### Message Types and Communication Modes Data Flow

The following charts enumerate by message type and communications mode each of the allowable transactions and their responses. Items marked “N/A” in the comment column will not be implemented in PDM2000 and are included here only for sake of completeness.

| MSG | COMM | TRAN | |
|---|---|---|---|
| TYPE | MODE | CODE | RESPONSE COMMENT |
| I. PDM TO SERVER: | | | |
| DataPostSet | Cont | | N/A* |
| (PDM to Server) | Stop | | N/A* |
| | More | ACK/NAK | |
| | None | ACK/NAK | |
| | | Post scheduled sensor data | |
| | | Post requested sensor data | |
| | | Post exception sensor data | |
| | | Post scheduled messaging response | |
| | | Post requested messaging response | N/A* |
| | | Post protocol and messaging profile block | |
| | | Protocol settings | |
| | | Messaging profile settings | |
| | | CRC | |
| | | Post operational mode and status | |
| | | Post non-profile device settings | N/A* |
| | | Post call statistics | N/A* |
| | | Post exception other data (multiple types) | e.g. profile failed |
| | | Post scheduled sensor data failure | |
| | | Post requested sensor data failure | |
| | | Post scheduled messaging item failure | |
| | | Post requested messaging item failure | N/A* |

(Note: Alarms not in COPD)

| | | | |
|---|---|---|---|
| Inquiry | Cont | InstructionSet | |
| (PDM to Server) | Stop | | N/A* |
| | More | | N/A* |
| | None | | N/A* |
| | | Inquiry transaction | |

(Note: PDM never sends an Inquiry if it has data to send itself)

| | | | |
|---|---|---|---|
| ACK-Message | Cont | InstructionSet | Response to InstructionSet + More |
| Confirmation- | Stop | | N/A* |
| (PDM to Server) | More | ACK + Cont | PDM now has data to send |
| | None | Goodbye | Response to InstructionSet + None |
| | | Confirmation transaction | |
| NAK-Message | Cont | Resend message | Try to resend reference message |
| Failure- | Stop | ACK + More/ACK + None | Stop sending reference message |
| (PDM to Server) | | | Server checks for other messages |
| | More | ACK + Cont | PDM now has data to send |
| | None | | N/A* |
| | | Failure transaction | |

(Note: Error information is in Transaction Value)

| | | | |
|---|---|---|---|
| Goodbye | Cont | | N/A* |
| (PDM to Server) | Stop | Goodbye | End message session |
| | More | | N/A* |
| | None | | N/A* |
| | | Goodbye transaction | |
| II. SERVER TO PDM: | | | |
| InstructionSet | Cont | N/A* | |
| (Server to PDM) | Stop | N/A* | |
| | More | ACK/NAK | |
| | None | ACK/NAK | |
| | | Set protocol and messaging profile block | |
| | | Protocol settings | |
| | | Messaging profile settings | |
| | | CRC | |
| | | Send protocol and messaging profile block | |
| | | Send requested sensor data | |
| | | Perform requested messaging item | N/A* |
| | | Set non-profile device settings | N/A* |
| | | Send non-profile device settings data | N/A* |
| | | Set operational mode & current status | |
| | | Send operational mode & current status | |
| | | Set call statistics (reset) | N/A* |
| | | Send call statistics | N/A* |
| | | Set no server message pending | Server has no messages to send |
| ACK-Message | Cont | DataPostSet | Response to DataPostSet + More |
| Confirmation | Stop | | N/A* |
| (Server to PDM) | More | Inquiry (usually) | Response to DataPostSet + None |
| | | | Server has messages |
| | None | Goodbye (usually) | Response to DataPostSet + None |
| | | | Server has no messages |
| | | Confirmation transaction | |

(Note: PDM ends all sessions. Server interrupt not used)

| | | | |
|---|---|---|---|
| NAK-Message | Cont | | N/A* |
| Failure | Stop | | N/A* |
| (Server to PDM) | More | Resend message or Stop | Server has messages |
| | None | Resend message or Stop | Server has no messages |
| | | Failure transaction | |

(Note: Error information is in Transaction Value)

| | | | |
|---|---|---|---|
| Goodbye | Cont | No response required | Normal end of message session |
| (Server to PDM) | Stop | | N/A* |
| | More | | N/A* |
| | None | | N/A* |
| | | Goodbye transaction | |

(Note: PDM ends all sessions. Server interrupt not used)

In the following web server communication embodiment of the present invention facilitating communications between a PhDx server and a Sleep Solutions server, the present invention employs an XML message schema, an XML transaction set schema for person demographics, and an XML transaction set schema for selection source.

### XML Message Schema

The XML schema used to validate the high-level XML message structure is shown below:

<?xml version=“1.0”?>
<Schema

name=“PhDxMsgSchema”
xmlns=“urn:schemas-microsoft-com:xml-data”
xmlns:dt=“urn:schemas-microsoft-com:datatypes”>
<ElementType name=’Msg' content=’eltOnly'>

<element type=’MsgID' minOccurs=’1' maxOccurs=’1'/>
<element type=’MsgDate' minOccurs=’1' maxOccurs=’1'/>
<element type=’MsgType' minOccurs=’1' maxOccurs=’1'/>
<element type=’CommMode' minOccurs=’1' maxOccurs=’1'/>
<element type=’ClientID' minOccurs=’1' maxOccurs=’1'/>
<element type=’ExternalID' minOccurs=’1' maxOccurs=’1'/>
<element type=’ReferenceID' minOccurs=’0' maxOccurs=’1'/>
<element type=’TranSetCount' minOccurs=’1' maxOccurs=’1'/>

</ElementType>
<ElementType name=’MsgID' content=’textOnly' dt:type=’int'/>
<ElementType name=’MsgDate' content=’textOnly' dt:type=’dateTime'/>
<ElementType name=’MsgType' content=’textOnly' dt:type=’int'/>
<ElementType name=’CommMode' content=’textOnly' dt:type=’int'/>
<ElementType name=’ClientID' content=’textOnly' dt:type=’int'/>
<ElementType name=’ExternalID' content=’textOnly' dt:type=’int'/>
<ElementType name=’ReferenceID' content=’textOnly' dt:type=’int'/>
<ElementType name=’TranSetCount' content=’textOnly' dt:type=’int'/>

</ Schema>

### XML Transaction Set Schema—Person Demographics

The XML schema used to validate the lower-level XML transaction set structure for a person demographics table post is shown below:

<?xml version=“1.0”?>
<Schema

name=“PhDxSSIpersonSchema”
xmlns=“urn:schemas-microsoft-com:xml-data”
xmlns:dt=“urn:schemas-microsoft-com:datatypes”>
<ElementType name=’TranSet' content=’eltOnly'>

<element type=’TranSetID' minOccurs=’1' maxOccurs=’1'/>
<element type=’TranSetCode' minOccurs=’1' maxOccurs=’1'/>
<element type=’TranCount' minOccurs=’1' maxOccurs=’1'/>
<element type=’Tran' minOccurs=’1' maxOccurs=’*'/>

</ElementType>
<ElementType name=’TranSetID' content=’textOnly' dt:type=’int'/>
<ElementType name=’TranSetCode' content=’textOnly' dt:type=’int'/>
<ElementType name=’TranCount' content=’textOnly' dt:type=’int'/>
<ElementType name=’Tran' content=’eltOnly'>

<element type=’TranID' minOccurs=’1' maxOccurs=’1'/>
<element type=’TranCode' minOccurs=’1' maxOccurs=’1'/>
<element type=’TranValue' minOccurs=’1' maxOccurs=’1'/>

</ElementType>
<ElementType name=’TranID' content=' textOnly=' dt:type=’int'/>
<ElementType name=’TranCode' content=' textOnly=' dt:type=’int'/>
<ElementType name=’TranValue' content=' eltOnly'>

<element type=’PersonCode' minOccurs=’0' maxOccurs=’1'/>
<element type=’DateCreated' minOccurs=’0' maxOccurs=’1'/>
<element type=’Gender' minOccurs=’1' maxOccurs=’1'/>
<element type=’DOB' minOccurs=’1' maxOccurs=’1'/>
<element type=’DOD' minOccurs=’0' maxOccurs=’1'/>
<element type=’IsActive' minOccurs=’0' maxOccur=’1'/>
<element type=’SSN' minOccurs=’0' maxOccurs=’1'/>
<element type=’Salutation' minOccurs=’0' maxOccurs=’1'/>
<element type=’FirstName' minOccurs=’1' maxOccurs=’1'/>
<element type=’MiddleName' minOccurs=’0' maxOccurs=’1'/>
<element type=’LastName' minOccurs=’1' maxOccurs=’1'/>
<element type=’PhoneWork' minOccurs=’0' maxOccurs=’1'/>
<element type=’PhoneHome' minOccurs=’0' maxOccurs=’1'/>
<element type=’Address1' minOccurs=’0' maxOccurs=’1'/>
<element type=’Address2' minOccurs=’0' maxOccurs=’1'/>
<element type=’City' minOccurs=’0' maxOccurs=’1'/>
<element type=’State' minOccurs=’0' maxOccurs=’1'/>
<element type=’Zip' minOccurs=’0' maxOccurs=’1'/>
<element type=’Country' minOccurs=’0' maxOccurs=’1'/>
<element type=’SelectionSourceCode' minOccurs=’0' maxOccurs=’1'/>

</ElementType>
<ElementType name=’PersonCode' content=’textOnly' dt:type=’string'/>
<ElementType name=’DateCreated' content=’textOnly' dt:type=’date'/>
<ElementType name=’Gender' content=’textOnly' dt:type=’string'/>
<ElementType name=’DOB' content=’textOnly' dt:type=’date'/>
<ElementType name=’DOD' content=’textOnly' dt:type=’date'/>
<ElementType name=’IsActive' content=’textOnly' dt:type=’int'/>
<ElementType name=’SSN' content=’textOnly' dt:type=’string'/>
<ElementType name=’Salutation' content=’textOnly' dt:type=’string'/>
<ElementType name=’FirstName' content=’textOnly' dt:type=’string'/>
<ElementType name=’MiddleName' content=’textOnly' dt:type=’string'/>
<ElementType name=’LastName' content=’textOnly' dt:type=’string'/>
<ElementType name=’PhoneWork' content=’textOnly' dt:type=’string'/>
<ElementType name=’PhoneHome' content=’textOnly' dt:type=’string'/>
<ElementType name=’Address1' content=’textOnly' dt:type=’string'/>
<ElementType name=’Address2' content=’textOnly' dt:type=’string'/>
<ElementType name=’City' content=’textOnly' dt:type=’string'/>
<ElementType name=’State' content=’textOnly' dt:type=’string'/>
<ElementType name=’Zip' content=’textOnly' dt:type' string'/>
<ElementType name=’Country' content=’textOnly' dt:type=’string'/>
<ElementType name=’SelectionSourceCode' content=’textOnly'

dt:type=’string'/>
</Schema>

### XML Transaction Set Schema—Selection Source

The XML schema used to validate the lower-level XML transaction set structure for a selection source table post is shown below:

<?xml version=“1.0”?>
<Schema

name=“PhDxSSISelectionSourceSchema”
xmlns=“urn:schemas-microsoft-com:xml-data”
xmlns:dt=“urn:schemas-microsoft-com:datatypes”>
<ElementType name=’TranSet' content=’eltOnly'>

<element type=’TranSetID' minOccurs=’1' maxOccurs=’1'/>
<element type=’TranSetCode' minOccurs=’1' maxOccurs=’1'/>
<element type=’TranCount' minOccurs=’1' maxOccurs=’1'/>
<element type=’Tran' minOccurs=’1' maxOccurs=’*'/>

</ElementType>
<ElementType name=’TranSetID' content=’textOnly' dt:type=’int'/>
<ElementType name=’TranSetCode' content=’textOnly' dt:type=’int'/>
<ElementType name=’TranCount' content=’textOnly' dt:type=’int'/>
<ElementType name=’Tran' content=’eltOnly'>

<element type=’TranID' minOccurs=’1' maxOccurs=’1'/>
<element type=’TranCode' minOccurs=’0' maxOccurs=’1'/>
<element type=’TranValue' minOccurs=’1' maxOccurs=’1'/>

</ElementType>
<ElementType name=’TranID' content=’textOnly' dt:type=’int'/>
<ElementType name=’TranCode' content=’textOnly' dt:type=’int'/>
<ElementType name=’TranValue' content=’eltOnly'>

<element type=’SelectionSourceCode' minOccurs=’1' maxOccurs=’1'/>
<element type=’FirstName' minOccurs=’1' maxOccurs=’1'/>
<element type=’LastName' minOccurs=’1' maxOccurs=’1'/>
<element type=’MailingName' minOccurs=’0' maxOccurs=’1'/>
<element type=’Company' minOccurs=’0' maxOccurs=’1'/>
<element type=’Address1' minOccurs=’0' maxOccurs=’1'/>
<element type=’Address2' minOccurs=’0' maxOccurs=’1'/>
<element type=’City' minOccurs=’0' maxOccurs=’1'/>
<element type=’State' minOccurs=’0' maxOccurs=’1'/>
<element type=’Zip' minOccurs=’0' maxOccurs=’1'/>
<element type=’Country' minOccurs=’0' maxOccurs=’1'/>
<element type=’ContactName' minOccurs=’0' maxOccurs=’1'/>
<element type=’Phone' minOccurs=’0' maxOccurs=’1'/>
<element type=’Fax' minOccurs=’0' maxOccurs=’1'/>
<element type=’OtherPhone1' minOccurs=’0' maxOccurs=’1'/>
<element type=’OtherPhone2' minOccurs=’0' maxOccurs=’1'/>
<element type=’Email' minOccurs=’0' maxOccurs=’1'/>
<element type=’UserField1' minOccurs=’0' maxOccurs=’1'/>
<element type=’UserField2' minOccurs=’0' maxOccurs=’1'/>
<element type=’UserField3' minOccurs=’0' maxOccurs=’1'/>
<element type=’UserField4' minOccurs=’0' maxOccurs=’1'/>

</ElementType>
<ElementType name=’SelectionSourceCode' content=’textOnly'

dt:type=’string'/>

<ElementType name=’FirstName' content=’textOnly' dt:type=’string'/>
<ElementType name=’LastName' content=’textOnly' dt:type=’string'/>
<ElementType name=’MailingName' content=’textOnly' dt:type=’string'/>
<ElementType name=’Company' content=’textOnly' dt:type=’string'/>
<ElementType name=’Address1' content=’textOnly' dt:type=’string'/>
<ElementType name=’Address2' content=’textOnly' dt:type=’string'/>
<ElementType name=’City' content=’textOnly' dt:type=’string'/>
<ElementType name=’State' content=’textOnly' dt:type=’string'/>
<ElementType name=’Zip' content=’textOnly' dt:type=’string'/>
<ElementType name=’Country' content=’textOnly' dt:type=’string'/>
<ElementType name=’ContactName' content=’textOnly' dt:type=’string'/>
<ElementType name=’Phone' content=’textOnly' dt:type=’string'/>
<ElementType name=’Fax' content=’textOnly' dt:type=’string'/>
<ElementType name=’OtherPhone1' content=’textOnly' dt:type=’string'/>
<ElementType name=’OtherPhone2' content=’textOnly' dt:type=’string'/>
<ElementType name=’Email' content=’textOnly' dt:type=’string'/>
<ElementType name=’UserField1' content=’textOnly' dt:type=’string'/>
<ElementType name=’UserField2' content=’textOnly' dt:type=’string'/>
<ElementType name=’UserField3' content=’textOnly' dt:type=’string'/>
<ElementType name=’UserField4' content=’textOnly' dt:type=’string'/>

</Schema>

### Example—Sleep Solutions Demographic and Selection Source Database Tables

The example below is for an upload of both the patient demographic table and the selection source table from a database at Sleep Solutions to a remote database at PhDx. The upload runs across an Internet connection. Note that the actual database types and structures can be and are very different at both sites. However, communication between the two database sites is seemless and automatic through the use of the XML schemas used by the communications process.

The full set of message tags is as follows:

<Msg xmlns=’x-schema:http://schemas.phdx.com/SSI/PhDxMsgSchema.xml'>

<MsgID>1</MsgID>
<MsgDate>1988-04-07T18:39:09</MsgDate>
<MsgType>1</MsgType><CommMode>1</CommMode><ClientID>1</ClientID><ExternalID>1</ExternalID><ReferenceID>1</ReferenceID>
<TranSetCount>2</TranSetCount>
<TranSet xmlns=’x-schema:http://schemas.phdx.com/SSI/PhDxSSIPersonSchema.xml'>

<TranSetID>1</TranSetID>
<TranSetCode>1</TranSetCode>
<TranCount>2</TranCount>
<Tran>

<TranID>1</TranID>
<TranValue>

<PersonCode> M000456789 </PersonCode><DateCreated>

2000-10-27 </DateCreated><Gender> M </Gender><DOB> 1965-09-16 </DOB><DOD>
1965-09-17 </DOD><IsActive> 1 </IsActive><SSN> 000456789 </SSN><Salutation>
Mr. </Salutation><FirstName> Joe </FirstName><MiddleName> X
</MiddleName><LastName> Patient </LastName><PhoneWork> 555-456-7890
</PhoneWork><PhoneHome> 555-987-6543 </PhoneHome><Address1> 1234 Main St
</Address1><Address2> Suite 2 </Address2><City> Anytown </City><State> NM
</State><Zip> 11111 </Zip><Country> USA </Country><SelectionSourceCode>
Doctor1 </SelectionSourceCode>

</TranValue></Tran>

<Tran>

<TranID>2 </TranID>
<TranValue>

<PersonCode> F000456666 </PersonCode><DateCreated>

2000-10-27 </DateCreated><Gender> F </Gender><DOB> 1970-12-25
</DOB><IsActive> 1 </IsActive><SSN> 000456666 </SSN><Salutation> Mrs
</Salutation><FirstName> Josephine </FirstName><MiddleName> Y
</MiddleName><LastName> Patient </LastName><PhoneWork> 555-111-2222
</PhoneWork><PhoneHome> 555-777-8888 </PhoneHome><Addressl> 22 Second St.
</Address1>Address2> Apt. 2 </Address2><City> Anytown </City><State> NM
</State><Zip> 11111 </Zip><Country> USA </Country><SelectionSourceCode>
Doctor1 </SelectionSourceCode>

</TranValue>

</Tran>

</TranSet>
<TranSet xmlns=’x-schema:http://schemas.phdx.com/SSI/PhDxSSISelectionSourceSchema.xml'>

<TranSetID>2</TranSetID>
<TranSetCode>2</TranSetCode>
<TranCount>2</TranCount>
<Tran>

<TranID>1</TranID>
<TranValue>

<SelectionSourceCode>Doctor1</SelectionSourceCode><FirstName>Fred</First

Name><LastName>Doctor</LastName><ContactName>Betty</ContactName><Address1>
33 Second St. </Address1><Address2> Suite 1122 </Address2><City> Anytown
</City><State> NM </State><Zip> 11111 </Zip><Country> USA </Country><Phone>
555-333-4444 </Phone><Fax> 555-444-5555 </Fax><Email> doctor1@xxx.yyy
</Email><UserField1> SpecialtyX </UserField1>

</TranValue>

</Tran>
<Tran>

<TranID>2</TranID>
<TranValue>

<SelectionSourceCode>Doctor2</SelectionSourceCode><FirstName>Leon</First

Name><LastName>Jones</LastName><ContactName>Herman</ContactName><Address1>
33 Second St. </Address1><Address2> Suite 1122 </Address2><City> Anytown
</City><State> NM </State><Zip> 11111 </Zip><Country> USA </Country><Phone>
555-333-4444 </Phone><Fax> 555-444-5555 </Fax><Email> doctor2@xxx.yyy
</Email><UserField1> SpecialtyZ </UserField1>

</TranValue>

</Tran>

</TranSet>

</Msg>

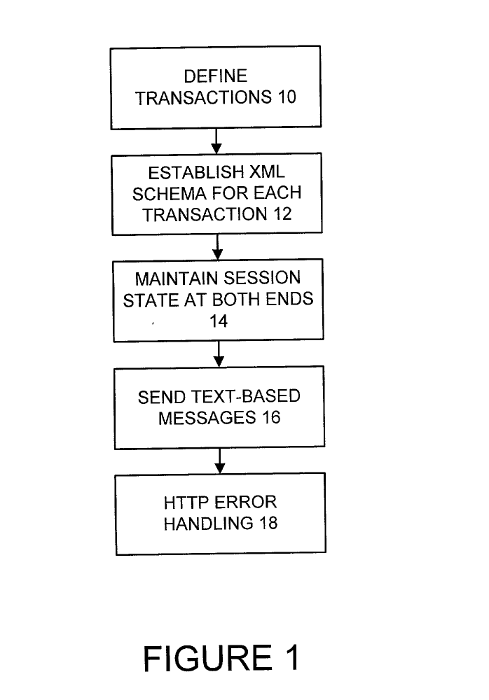

The method of the present invention provides communications between networked computing devices using a high-level Extensible Markup Language (XML) structure. To accomplish this, as illustrated in FIG. 1, a plurality of desired transactions to be communicated between the networked computing devices are defined 10 and an XML schema is established for each transaction 12. Communication session state information is maintained on each computing device during a session 14. Text-based transaction messages are sent 16 between the networked computing devices using Hypertext Transport Protocol (HTTP) and can include both data and instructions.

The invention is not limited by how the networked computing devices are networked to each and can include wired LANs, wireless LANs, wired WANs, wireless WANs, wired Internet, and wireless Internet. Use of XML and HTTP allows the networked computing devices to employ different database types and structures. The XML schemas allow the present invention to implement flow of control, prioritization and interrupts between said networked computing devices and HTTP provides error handling 18 between the networked computing devices. Security can be provided via HTTPS.

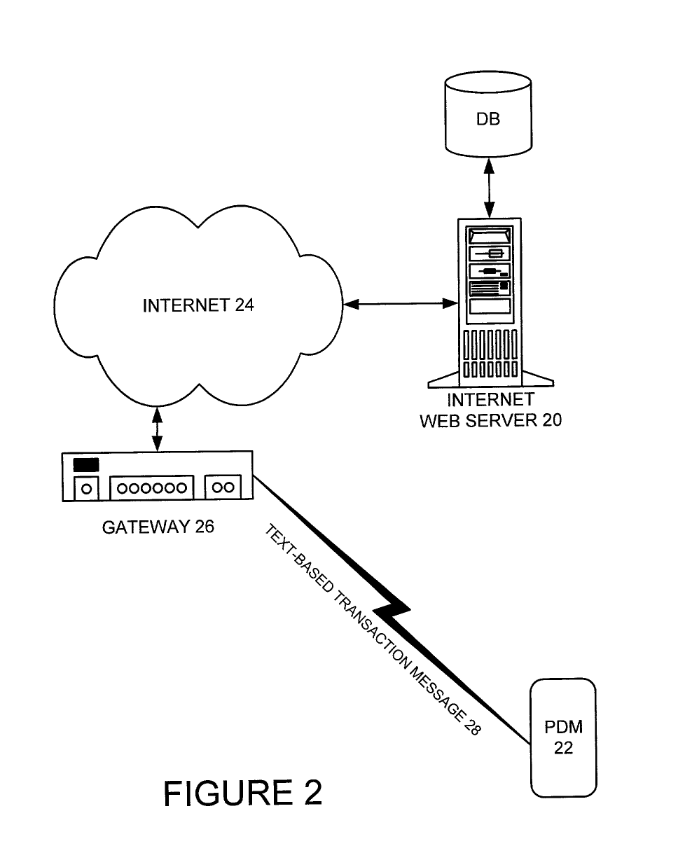

In one preferred embodiment, as illustrated in FIG. 2, the networked computing devices are an Internet web server 20 and a wireless patient data monitor 22 connected over the Internet 24 through a gateway 26. The text-based transaction messages 28 are used to provide bi-directional transmission of data and instructions.

Although disclosed with respect to specific embodiments, one of ordinary skill in the art will recognize that various modification can be made without departing from the scope of the present invention, which is limited only by the claims below.

We claim:

1. A method for providing communications between networked computing devices using a high-level Extensible Markup Language (XML) structure, comprising:
defining a plurality of desired transactions to be communicated between the networked computing devices;
establishing an XML schema for each transaction;
establishing a communication session between said networked computing devices;
maintaining communication session state information on each computing device; and
sending a text-based transaction messages between said networked computing devices using Hypertext Transport Protocol (HTTP).

2. The method of claim 1, wherein a transaction message contains both data and instructions.

3. The method of claim 1, wherein said networked computing devices are networked to each other over a network selected from the group consisting of: wired LANs, wireless LANs, wired WANs, wireless WANs, wired Internet, and wireless Internet.

4. The method of claim 1, wherein said networked computing devices employ different database types and structures.

5. The method of claim 1, wherein said desired transactions implement flow of control, prioritization and interrupts between said networked computing devices.

6. The method of claim 1, wherein said desired transactions implement error handling between said networked computing devices.

7. The method of claim 1, wherein said text-based transaction messages are sent securely using HTTPS.

8. The method of claim 1, wherein said networked computing devices are an Internet web server and a wireless patient monitor and said text-based transaction messages are used to provide bidirectional transmission of data and instructions.

9. A system for providing communications between networked computing devices using a high-level Extensible Markup Language (XML) structure, comprising:
at least two computing devices connected to each other on a network;
software instructions on said computing devices adapted to define an XML schema for each of a plurality of desired transactions to be communicated between the networked computing devices;
software instructions on said computing devices adapted to establish a communication session between said networked computing devices;
software instructions on said computing devices adapted to maintain communication session state information on each computing device; and
software instructions on said computing devices adapted to send a text-based transaction messages between said networked computing devices using Hypertext Transport Protocol (HTTP).

10. The system of claim 9, wherein a transaction message contains both data and instructions.

11. The system of claim 9, wherein said network is selected from the group consisting of:
wired LANs, wireless LANs, wired WANs, wireless WANs, wired Internet, and wireless Internet.

12. The system of claim 9, wherein each computing devices includes different database type and structure.

13. The system of claim 9, wherein said software instructions on said computing devices are further adapted to implement flow of control, prioritization and interrupts between said networked computing devices.

14. The system of claim 9, wherein said software instructions on said computing devices are further adapted to implement error handling between said networked computing devices.

15. The system of claim 9, wherein said software instructions on said computing devices is further adapted to send said text-based transaction messages securely using HTTPS.

16. The system of claim 9, wherein said computing devices comprise an Internet web server and a wireless patient monitor.
